(19) United States
(12) Patent Application Publication
(10) Pub. No.: US 2011/0034628 A1
(43) Pub. Date: Feb. 10, 2011

(54) BRANCHED POLYOLS CONTAINING ON AVERAGE TWO OR MORE HYDROXYL GROUPS PER MOLECULE,THEIR PREPARATION AND USE

(75) Inventors: Gunther Ott, Munster (DE); Bjorn Feldmann, Munster (DE); Sabine Holtschulte, Senden (DE); Andreas Janssen, Steinfurt (DE); Christin Sobbe, Munster (DE); Karl-Heinz Joost, Drensteinfurt (DE)

Correspondence Address: Mary E. Golota;Cantor Colburn LLP, 201 W. Big Beaver Road, Suite 1101, Troy, MI, 48084, US

(73) Assignee: BASF COATINGS AG, Munster (DE)

(21) Appl. No.: 12/300,535

(22) PCT Filed: May 9, 2007
(86) PCT No.: PCT/EP2007/004082

§ 371 Date: Jan. 26, 2010

(30) Foreign Application Priority Data
May 11, 2006 (DE) 102006021917.1

(51) Int. Cl. C08G 18/72; C08L 75/04

(52) U.S. Cl. 524/590; 528/85

(57) ABSTRACT

Disclosed are branched polyols (A) having two or more hydroxyl groups per molecule prepared by providing a polyisocyanate (A1) containing per molecule two or more isocyanate groups and either two or more hard segments (a11) which as part of a thermoset three-dimensional network raise its glass transition temperature, or two or more soft segments which as part of a thermoset three-dimensional network lower its glass transition temperature; and reacting the polyisocyanate (A1) with a polyol (A2) in a molar ratio (A2):(A1) of ≧2 and an equivalent ratio of [X+OH]:NCO≧2; wherein polyol (A2) has the general formula I: X [—R(—OH)ₙ]ₘ, and the variables have the following definitions: n is a number from 1 to 5, m is 1 or 2, X is an isocyanate-reactive functional group, and R is a divalent to pentavalent organic radical, with the proviso that R comprises at least one hard segment (a11) if (A1) comprises soft segments.

### FIELD OF THE INVENTION

The present invention relates to new branched polyols containing on average two or more hydroxyl groups per molecule. The present invention also relates to a new process for preparing branched polyols containing on average two or more hydroxyl groups per molecule. The present invention further relates to the use of the new branched polyols containing on average two or more hydroxyl groups per molecule and of the branched polyols containing on average two or more hydroxyl groups per molecule that are prepared by the new process.

### PRIOR ART

Two-component systems which comprise a hydroxyl-containing component (I) and a polyisocyanate-comprising component (II) are known from European patent EP 0 983 323 B1. Said hydroxyl-containing component (I) comprises a hydroxyl-containing, film-forming binder and a low molecular mass branched diol of the general formula:

HO—CH₂—CR(C₂H₅)—CH₂—OH,

in which the variable R is an alkyl group having three to six carbon atoms—such as 2-n-butyl-2-ethyl-1,3-propanediol, for example—as reactive diluent.

The coating materials prepared from the known two-component systems are said to exhibit high dilutability, a low volatile organic compounds content, good mixing properties, and low application viscosities. The applied coating materials are said to display rapid curing at low temperatures and to give coatings with high hardness, ready polishability, effective resistance to water, acids, and organic solvents, and an outstanding service life. As clearcoat materials they are said to give transparent coatings and no longer to exhibit a “strike-in” effect into basecoat films.

A disadvantage, however, is that the scratch resistance of the coatings goes down after a prolonged time, in an unpredictable way.

A further disadvantage is that the use of other diols typically used in the field of coating materials, such as 3-methyl-1,3-propanediol, 1,6-hexanediol, 2,2-dimethyl-1,3-propanediol, 2,2,4-trimethyl-1,3-pentanediol, hydroxypivalic hydroxypivalate or 1,4-cyclohexanedimethanol, as reactive diluents causes problems. For instance, these diols are found to be incompatible with or insoluble in the components (I) in question, and the coating materials in question have an unfavorable ratio of pot life to drying time, have slow drying and/or a marked strike-in effect, and give turbid, soft coatings. All of this, however, sensitively restricts the possibilities for physical modification of the known coating materials with the aim of improving their profile of performance properties and the corresponding profile of the coatings produced from them.

### PROBLEM ADDRESSED BY THE INVENTION

The object on which the present invention was based was that of increasing significantly the number of diols and polyols which can be used with advantage in two-component and multicomponent systems and so of expanding the possibilities for physical modification of two-component and multicomponent systems with the aim of improving the profile of performance properties of the coatings and coating materials prepared from them.

A further object of the invention was to provide new polyols which can be prepared easily and with excellent reproducibility from a particularly large number of readily available starting products.

The new polyols ought to be outstandingly useful as new thermally curable materials or as constituents of new thermally curable materials.

The new thermally curable materials ought to be storage-stable and transportable and ought to have particularly outstanding suitability as new coating materials, adhesives, sealants, and precursors for moldings and films, especially coating materials, more particularly coating materials which are prepared a short time prior to their use from two-component or multicomponent systems.

The new coating materials ought in particular to be outstandingly suitable as electrocoat materials, primers, surfacers, priming systems, basecoat, solid-color topcoat, and clearcoat materials, especially clearcoat materials.

The new thermally curable materials ought additionally to be outstandingly suitable for producing new thermoset materials, especially coatings, adhesive layers, seals, moldings, and films, particularly coatings.

The new thermally curable materials ought to have a high solids content, a low VOC, a very low application viscosity, and, when prepared from two-component and multicomponent systems, a particularly long pot life or processing life. In particular they ought no longer to suffer separation of constituents and/or phase separation.

The new coatings ought in particular to be new electrocoats, primer coats, surfacer coats, antistonechip primer coats, basecoats, solid-color topcoats, and clearcoats, especially clearcoats, more particularly clearcoats of multicoat color and/or effect paint systems, with an outstanding profile of properties.

In particular the new coatings ought to exhibit high etch resistance, chemical resistance, weathering stability, and moisture resistance, very good flow, an outstanding overall appearance, very good wet scratch resistance, and particularly high dry scratch resistance.

### SOLUTION PROVIDED BY THE INVENTION

Found accordingly have been the new, branched polyols (A) containing on average two or more hydroxyl groups per molecule, which are preparable by reacting
(A1) at least one polyisocyanate containing on average per molecule two or more isocyanate groups and also
   two or more hard segments (a 11) which as part of a thermoset three-dimensional network raise its glass transition temperature, or
   two or more soft segments which as part of a thermoset three-dimensional network lower its glass transition temperature, with
(A2) at least one polyol of the general formula I:

X[—R(—OH)ₙ]ₘ (I),
in which the index and the variables have the following definitions:
n is a number from 1 to 5,
m is 1 or 2,
X is an isocyanate-reactive functional group, and
R is a divalent to pentavalent organic radical, with the proviso that R comprises or consists of at least one hard segment (a11) if (A1) comprises soft segments,
   in a molar ratio (A2):(A1) of ≧2 and an equivalent ratio of [X+OH]:NCO≧2, and which are referred to below as “polyols (A) of the invention”.

Additionally found has been the new process for preparing the polyols (A) of the invention, which involves reacting
(A1) at least one polyisocyanate containing on average per molecule two or more isocyanate groups and also
   two or more hard segments (a 11) which as part of a thermoset three-dimensional network raise its glass transition temperature, or
   two or more soft segments which as part of a thermoset three-dimensional network lower its glass transition temperature, with
(A2) at least one polyol of the general formula I:

X[—R(—OH)ₙ]ₘ (I),
in which the index and the variables have the following definitions:
n is a number from 1 to 5,
m is 1 or 2,
X is an isocyanate-reactive functional group, and
R is a divalent to pentavalent organic radical, with the proviso that R comprises or consists of at least one hard segment (a11) if (A1) comprises soft segments,
   in a molar ratio (A2):(A1) of ≧2 and an equivalent ratio of [X+OH]:NCO≧2, until free isocyanate groups are no longer detectable in the reaction mixture, and which is referred below as “process of the invention”.

Found not least has been the new use of the polyols (A) of the invention and of the polyols (A) of the invention prepared by the process of the invention as, or for preparing, thermally curable materials, which is referred to below as “inventive use”.

Additional subject matter of the invention will become apparent from the description.

### ADVANTAGES OF THE INVENTION

In light of the prior art it was surprising and unforeseeable for the skilled worker that the object on which the present invention was based could be achieved by means of the polyols (A) of the invention, the process of the invention, and the inventive use.

On account of the polyols (A) of the invention it was possible to increase significantly the number of diols and polyols which could be used with advantage in two-component and multicomponent systems and so to expand considerably the possibilities for physical modification of two-component and multicomponent systems with the aim of improving the profile of performance properties of the coatings and coating materials prepared from them.

The polyols (A) of the invention were preparable easily and with very good reproducibility from a particularly large number of readily available starting products.

The polyols (A) of the invention were outstandingly useful as new thermally curable materials or as constituents of new thermally curable materials.

The thermally curable materials of the invention were storage-stable and transportable and were outstandingly suitable in particular as new coating materials, adhesives, sealants, and precursors for moldings and films, especially coating materials, more particularly coating materials which were prepared a short time prior to their use from two-component or multicomponent systems.

The coating materials of the invention were outstandingly suitable in particular as electrocoat materials, primers, surfacers, priming systems, basecoat, solid-color topcoat, and clearcoat materials, especially clearcoat materials.

The thermally curable materials of the invention were also outstandingly suitable for producing new thermoset materials, especially coatings, adhesive layers, seals, moldings, and films, particularly coatings.

At the same time the thermally curable materials of the invention had a high solids content, a low VOC, a very low application viscosity and, when prepared from two-component or multicomponent systems, a particularly long pot life or processing life. In particular they no longer suffered any separation of constituents and/or any phase separation.

The coatings of the invention were, in particular, new electrocoats, primer coats, surfacer coats, antistonechip primer coats, basecoats, solid-color topcoats, and clearcoats, especially clearcoats, more particularly clearcoats of multicoat color and/or effect paint systems, with an outstanding profile of properties.

In particular the coatings of the invention exhibited high etch resistance, chemical resistance, weathering stability, and moisture resistance, very good flow, an outstanding overall appearance, very good wet scratch resistance, and particularly high dry scratch resistance.

### DETAILED DESCRIPTION OF THE INVENTION

The polyols (A) of the invention are preferably preparable by means of the process of the invention.

The process of the invention starts from at least one, especially one, polyisocyanate (A1) comprising on average two or more, preferably 2.5 to 7, and in particular 2.5 to 6 isocyanate groups per molecule.

The polyisocyanate (A1) for inventive use further comprises two or more, preferably three or more hard segments (a 11), which as part of a thermoset three-dimensional network raise its glass transition temperature. These hard segments (a11) are, as is known, rigid structures of restricted spatial mobility.

Alternatively the polyisocyanate (A1) for inventive use comprises two or more, preferably three or more soft segments which as part of a thermoset three-dimensional network lower its glass transition temperature. These soft segments are, as is known, flexible structures whose spatial mobility is high, such as linear alkylene groups having preferably 3 to 30, more preferably 4 to 10, and, in particular, 6 carbon atoms, polyoxyalkylene groups, polyimine groups or siloxane groups, for example.

The polyisocyanate (A1) preferably comprises at least one group (al 2) selected from the group consisting of isocyanurate, urea, urethane, biuret, uretdione, iminooxadiazinedione, carbodiimide, and allophanate groups.

The polyisocyanate (A1) for inventive use preferably comprises two or more, preferably three or more hard segments (a11).

The hard segments (a11) of the polyisocyanates (A1) are preferably selected from the group consisting of saturated and unsaturated cycloaliphatic groups (a13) which are unsubstituted or substituted by inert substituents (a14) and contain heteroatoms (a15) or are free from heteroatoms (a15), and of aromatic groups (a13) which are unsubstituted or substituted by inert substituents (a14) and contain heteroatoms (a15) or are free from heteroatoms (a15).

Preferably the heteroatoms (a15) of the groups (a 11) are selected from the group consisting of boron, nitrogen, phosphorus, oxygen, and sulfur atoms.

The inert substituents (a14) of the groups (a11) are preferably selected from the group consisting of halogen atoms, monovalent, unsubstituted, and perfluorinated aliphatic, cycloaliphatic, and aromatic groups, nitro groups, nitrile groups, and aliphatic, cycloaliphatic or aromatic groups which are linked to the hard segments (a11) of the polyisocyanates (A1) via a carbon-carbon bond or via a divalent linking functional group (a16).

The divalent linking functional groups (a16) are preferably selected from the group consisting of ether, thioether, carboxylic ester, thiocarboxylic ester, carbonate, thiocarbonate, phosphoric ester, thiophosphoric ester, phosphonic ester, thiophosphonic ester, phosphite, thiophosphite, sulfonic ester, amide, amine, thioamide, phosphoramide, thiophosphoramide, phosphonamide, thiophosphonamide, sulfonamide, imide, hydrazide, urethane, thiourethane, urea, thiourea, allophanate, carbonyl, thiocarbonyl, sulfone, and sulfoxide groups.

The hard segments (a11) of the polyisocyanates (A1) are preferably selected from the group consisting of saturated cycloaliphatic groups (a13) which are unsubstituted or substituted by monovalent aliphatic groups (a14) having 1 to 4 carbon atoms and are free from heteroatoms (a15), and of aromatic groups (a13) which are unsubstituted or substituted by monovalent aliphatic groups (a14) having 1 to 4 carbon atoms and are free from heteroatoms (a15).

With particular preference the saturated, cycloaliphatic hard segments (a11), free from heteroatoms (a15), of the polyisocyanates (A1) are derived from cycloaliphatic compounds (a131) selected from the group consisting of substituted and unsubstituted, monocyclic, bicyclic, tricyclic, and tetracyclic bridge compounds and spirocyclic compounds; and the aromatic hard segments (a11), free from heteroatoms (a15), are derived from aromatic compounds (a131) selected from the group consisting of substituted and unsubstituted, monocyclic and polycyclic, fused and nonfused aromatics.

With very particular preference the unsubstituted, monocyclic, bicyclic, tricyclic, and tetracyclic bridge compounds (a131) and spirocyclic compounds (a131) are selected from the group consisting of cyclopropane, cyclobutane, cyclopentane, cyclohexane, cycloheptane, cyclooctane, p-menthane, m-menthane, o-menthane, 1,1,2,3-tetramethylcyclohexane, 1,1,3,3-tetramethylcyclohexane, thujane, carane, pinane, bornane, norcarane, norpinane, norbornane, camphane, 2-ethylpinane, 2,4,7,7-tetramethylnorcarane, 2,2-dimethylnorbornane, hydroindane, dicyclohexylmethane, 2,2-dicyclohexylpropane, perhydronaphthalene, perhydroacenaphthene, perhydrophenanthrene, perhydroanthracene, perhydrofluorene, abietane, pimarane, labdane, phyllocladane, gibbane, gonane, cholestane, lanostane, ambrane, onacerane, oleanane, ursane, gammacerane, lupane, bicyclo[2.2.2]octane, bicyclo[3.2.1]octane, bicyclo[5.2.0]nonane, bicyclo[4.3.2]undecane, tricyclo[2.2.1.0^{2,6}]heptane, tricyclodecane, tricyclo[5.4.0.0^{2,9}]undecane, tricyclo[5.3.2.0^{4,9}]dodecane, tricyclo[5.5.1.0^{3,11}]tridecane, perhydro-1,4-ethano-5,8-methanoanthracene, adamantane, spiro[3.3]heptane, spiro[3.4]octane, spiro[4.5]decane, spirobicyclohexane, and dispiro[5.1.7.2]heptadecane; and the monocyclic and polycyclic, fused and nonfused aromatics (a131) are selected from the group consisting of benzene, toluene, xylene, tetramethylxylene, biphenyl, diphenylmethane, 2,2-diphenylpropane, 1,2-, 1,3- or 1,4-diphenylbenzenes (terphenyls), positionally isomeric quaterphenylenes, 1,3,5-triphenylbenzene, naphthalene, acenaphthylene, acenaphthene, phenanthrene, fluorene, anthracene, chrysene, pyrene, and fluoranthene; in particular, benzene, toluene, tetramethylxylene, diphenylmethane, and 2,2-diphenylpropane.

In particular, the compounds (a131) are selected from the group consisting of cyclobutane, cyclopentane, cyclohexane, 1,1,3,3-tetramethylcyclohexane, 2-ethyl-1,3,3-trimethylcyclohexane, 3-propyl-1,3,3-trimethylcyclohexane, 4-butyl-1,3,3-trimethylcyclohexane, ethylcyclohexane, propylcyclohexane, butylcyclohexane, dicyclohexylmethane, 2,2-dicyclohexylpropane, benzene, toluene, tetramethylxylene, diphenylmethane, and 2,2-diphenylpropane.

Especially advantageous polyisocyanates (A1) can be selected from the group consisting of isophorone diisocyanate (i.e., 5-isocyanato-1-isocyanatomethyl-1,3,3-trimethylcyclohexane), 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane 2,4′-diisocyanate, dicyclohexylmethane 4,4′-diisocyanate, tolylene 2,4- and 2,6-diisocyanate, phenylene 1,2-, 1,3- or 1,4-diisocyanate, naphthalene 1,4-, 1,3-, 1,2-, 1,5- or 2,5-diisocyanate, propane-2,2-di(phenyl 4′-diisocyanate), methanedi(phenyl 4′-isocyanates) or 1,1′-diphenyl 4,4′-diisocyanate, and also the oligomers of these diisocyanates.

It is a particular advantage in this context if the oligomers (A1) of the diisocyanates (A1) comprise groups selected from the group consisting of isocyanurate, urea, urethane, biuret, uretdione, iminooxadiazinedione, carbodiimide, and allophanate groups (a12).

In accordance with the invention the polyisocyanate (A1) is reacted with at least one, especially one, polyol (A2) of the general formula I:

X[R(—OH)ₙ]ₘ (I),

in which the index and the variables have the following definitions:
n is a number from 1 to 5, preferably an integer from 1 to 5, and in particular 1 or 2,
m is 1 or 2, in particular 1,
X is an isocyanate-reactive functional group preferably selected from the group consisting of hydroxyl groups, thiol groups, primary amino groups, and secondary amino groups —NH—, especially hydroxyl groups,
R is a divalent to pentavalent, preferably divalent or trivalent, and in particular divalent organic radical, with the proviso that R comprises or consists of at least one, especially one, hard segment (a11) if (A1) comprises soft segments, preferably those described above.

The organic radical R of the general formula I is preferably selected from the group consisting of
radicals which comprise saturated and unsaturated, aliphatic, cycloaliphatic, and aromatic radicals which are unsubstituted or substituted by inert substituents (a14), contain heteroatoms (a15) or are free from heteroatoms (a15), and contain or are free from divalent linking functional groups (a16), and
radicals which consist of saturated and unsaturated, aliphatic, cycloaliphatic, and aromatic radicals which are unsubstituted or substituted by inert substituents (a14), contain heteroatoms (a15) or are free from heteroatoms (a15), and contain or are free from divalent linking functional groups (a16).

With particular preference the radical R contains 2 to 50 carbon atoms.

The polyol (A2) of the general formula I is preferably selected from the group consisting of diols, triols, tetrols, pentitols, hexitols, thioalkanols, and alkanolamines, more preferably diols, triols and alkanolamines, and especially the diols.

Where the polyisocyanates (A1) contain the above-described hard segments (a 11), which is preferred in accordance with the invention, it is preferred to use polyols (A2) which contain soft segments.

Examples of suitable triols, tetrols, pentitols, and hexitols (A2) of this kind are trimethylolmethane, trimethylolethane, trimethylolpropane, glycerol, erythritol, threitol, pentaerythritol, dipentaerythritol, homopentaerythritol, arabitol, adonitol, xylitol, mannitol, sorbitol, dulcitol, and inositol.

Examples of suitable thioalkanols (A2) of this kind are thioethanol and thiopropanol.

Examples of suitable alkanolamines (A2) of this kind are aminoethanol and diethanolamine.

Examples of suitable diols (A2) of this kind are cyclic and acyclic C₉-C₁₆ alkanes functionalized with two hydroxyl groups.

As C₉-C₁₆ alkanes from which the diols (A2) are derived, suitability is possessed in principle by all linear and branched, preferably branched, alkanes having 9 to 16 carbon atoms.

The C₉-C₁₆ alkanes from which the compounds (B) are derived are preferably selected from the group consisting of 2-methyloctane, 4-methyloctane, 2,3-dimethylheptane, 3,4-dimethylheptane, 2,6-dimethylheptane, 3,5-dimethylheptane, 2-methyl-4-ethylhexane, isopropylcyclohexane, 4-ethyloctane, 2,3,4,5-tetramethylhexane, 2,3-diethylhexane, 1-methyl-2-n-propylcyclohexane, 2,4,5,6-tetramethylheptane, 3-methyl-6-ethyloctane, 1-ethylbutylcyclohexane, positionally isomeric diethyloctanes, 3,4-dimethyl-5-ethylnonane, 4,6-dimethyl-5-ethylnonane, 3,4-dimethyl-7-ethyldecane, 3,6-diethylundecane, 3,6-dimethyl-9-ethylundecane, 3,7-diethyldodecane and 4-ethyl-6-isopropylundecane.

The C₉-C₁₆ alkanes are more preferably positionally isomeric diethyloctanes.

Preferred diols (A2) are, accordingly, the positionally isomeric diethyloctanediols, more preferably those containing linear C₈ carbon chains.

With respect to the two ethyl groups, the C₈ carbon chain may have the substitution pattern 2,3, 2,4, 2,5, 2,6, 2,7, 3,4, 3,5, 3, 6 or 4,5.

Similarly, with respect to the two hydroxyl groups, the C₈ carbon chain may have the substitution pattern 1,2, 1,3, 1,4, 1,5, 1,6, 1,7, 1,8, 2,3, 2,4, 2,5, 2,6, 2,7, 2,8, 3,4, 3,5, 3,6, 3,7, 3,8, 4,5, 4,6, 4,8, 5,6, 5,7, 5,8, 6,7, 6,8 or 7,8.

The diethyloctanediols (A2) are preferably selected from the group consisting of

2,3-diethyloctane-1,2-, -1,3-, -1,4-, -1,5-, -1,6-, -1,7-, -1,8-, -2,3-, -2,4-, -2,5-, -2,6-, -2,7-, -2,8-, -3,4-, -3,5-, -3,6-, -3,7-, -3,8-, -4,5-, -4,6-, -4,7-, -4,8-, -5,6-, -5,7-, -5,8-, -6,7-, -6,8-, and -7,8-diol,
2,4-diethyloctane-1,2-, -1,3-, -1,4-, -1,5-, -1,6-, -1,7-, -1,8-, -2,3-, -2,4-, -2,5-, -2,6-, -2,7-, -2,8-, -3,4-, -3,5-, -3,6-, -3,7-, -3,8-, -4,5-, -4,6-, -4,7-, -4,8-, -5,6-, -5,7-, -5,8-, -6,7-, -6,8-, and -7,8-diol,
2,5-diethyloctane-1,2-, -1,3-, -1,4-, -1,5-, -1,6-, -1,7-, -1,8-, -2,3-, -2,4-, -2,5-, -2,6-, -2,7-, -2,8-, -3,4-, -3,5-, -3,6-, -3,7-, -3,8-, -4,5-, -4,6-, -4,7-, -4,8-, -5,6-, -5,7-, -5,8-, -6,7-, -6,8-, and -7,8-diol,
2,6-diethyloctane-1,2-, -1,3-, -1,4-, -1,5-, -1,6-, -1,7-, -1,8-, -2,3-, -2,4-, -2,5-, -2,6-, -2,7-, -2,8-, -3,4-, -3,5-, -3,6-, -3,7-, -3,8-, -4,5-, -4,6-, -4,7-, -4,8-, -5,6-, -5,7-, -5,8-, -6,7-, -6,8-, and -7,8-diol,
2,7-diethyloctan-1,2-, -1,3-, -1,4-, -1,5-, -1,6-, -1,7-, -1,8-, -2,3-, -2,4-, -2,5-, -2,6-, -2,7-, -2,8-, -3,4-, -3,5-, -3,6-, -3,7-, -3,8-, -4,5-, -4,6-, -4,7-, -4,8-, -5,6-, -5,7-, -5,8-, -6,7-, -6,8-, and -7,8-diol,
3,4-diethyloctane-1,2-, -1,3-, -1,4-, -1,5-, -1,6-, -1,7-, -1,8-, -2,3-, -2,4-, -2,5-, -2,6-, -2,7-, -2,8-, -3,4-, -3,5-, -3,6-, -3,7-, -3,8-, -4,5-, -4,6-, -4,7-, -4,8-, -5,6-, -5,7-, -5,8-, -6,7-, -6,8-, and -7,8-diol,
3,5-diethyloctane-1,2-, -1,3-, -1,4-, -1,5-, -1,6-, -1,7-, -1,8-, -2,3-, -2,4-, -2,5-, -2,6-, -2,7-, -2,8-, -3,4-, -3,5-, -3,6-, -3,7-, -3,8-, -4,5-, -4,6-, -4,7-, -4,8-, -5,6-, -5,7-, -5,8-, -6,7-, -6,8-, and -7,8-diol,
3,6-diethyloctane-1,2-, -1,3-, -1,4-, -1,5-, -1,6-, -1,7-, -1,8-, -2,3-, -2,4-, -2,5-, -2,6-, -2,7-, -2,8-, -3,4-, -3,5-, -3,6-, -3,7-, -3,8-, -4,5-, -4,6-, -4,7-, -4,8-, -5,6-, -5,7-, -5,8-, -6,7-, -6,8-, and -7,8-diol, and
4,5-diethyloctane-1,2-, -1,3-, -1,4-, -1,5-, -1,6-, -1,7-, -1,8-, -2,3-, -2,4-, -2,5-, -2,6-, -2,7-, -2,8-, -3,4-, -3,5-, -3,6-, -3,7-, -3,8-, -4,5-, -4,6-, -4,7-, -4,8-, -5,6-, -5,7-, -5,8-, -6,7-, -6,8-, and -7,8-diol.

The two ethyl groups are preferably in 2,4-position.

The two hydroxyl groups are preferably in 1,5-position.

As a diol (A2) of the type described above, use is made in particular of 2,4-diethyloctane-1,5-diol.

The positionally isomeric diethyloctanediols (A2) are compounds known per se and can be prepared by conventional synthesis methods of organic chemistry, such as base-catalyzed aldol condensation, or are obtained as by-products of chemical industrial syntheses such as the preparation of 2-ethylhexanol.

Further examples of suitable diols (A2) are known from German patent application DE 199 48 004 A1, page 5 line 38 to page 6 line 7, and from European patent EP 0 983 323 B1, page 2 paragraphs [0010] and [0011], and page 7 paragraph [0055].

In this context it proves a very particular advantage of the process of the invention that even the diols described as disadvantageous in the European patent EP 0 983 323 B1, namely 3-methyl-1,3-propanediol, 1,6-hexanediol, 2,2-dimethyl-1,3-propanediol, 2,2,4-trimethyl-1,3-pentanediol, hydroxypivalic hydroxypivalate or 1,4-cyclohexanedimethanol, can be used without problems in the context of the present invention.

Where the polyisocyanates (A1) contain the above-described soft segments, which is less preferred in accordance with the invention, it is preferred to use polyols (A2) which contain hard segments (a11). Preferably the above-described hard segments (a11) are used.

Examples of suitable polyols (A2) of this kind are 1,2-, 1,3-, and 1,4-dihydroxycyclohexane and 1,2-, 1,3-, and 1,4-cyclohexanedimethanol.

In the process of the invention the polyol (A2) is reacted with the polyisocyanate (A1) in a molar ratio (A2):(A1) of ≧2, preferably ≧2 to 5, and an equivalent ratio of [X+OH]:NCO≧2, preferably ≧2 to 4.

In the process of the invention it is also possible for up to 30 mol % of the polyol (A2) of the general formula Ito be replaced by at least one compound (A3) of the general formula II:

X—R¹ (II),

in which the variable X has the definition indicated above and the variable R¹ is a monovalent organic radical.

The radical R¹ is preferably selected from the group consisting of saturated and unsaturated, aliphatic and cycloaliphatic groups (r11) which are unsubstituted or substituted by inert substituents (a14), contain heteroatoms (a15) or are free from heteroatoms (a15), and aromatic groups (r11) which are unsubstituted or substituted by inert substituents (a14) and contain heteroatoms (a15) or are free from heteroatoms (a15), and also groups which contain two or more different groups (r11). The inert substituents may be linked to the groups (r11) with the divalent linking functional groups (a16). The two or more different groups (r11) may also be linked to one another via the groups (a16).

The group (r11) contains preferably 1 to 1000, more preferably 2 to 750, and in particular 2 to 500 carbon atoms.

With particular preference the group (r11) is a saturated aliphatic group.

With very particular preference X is a hydroxyl group.

In particular the compounds (A3) are low molecular mass and oligomeric aliphatic monoalcohols such as 2-ethylhexanol, oligomeric polyisobutylen-1-ol having a number-average molecular weight of 250 daltons, or oligomeric reaction products of epsilon-caprolactone with monoalcohols.

Where the compounds (A3) are used the molar ratio [(A2)+(A3)]:(A1) is ≧2, preferably ≧2 to 5, and the equivalent ratio [X+OH]:NCO is ≧2, preferably ≧2 to 4.

The reaction of (A1) with (A2) and also, if desired, (A3) can be carried out in the presence of a catalyst of the kind typically used to catalyze the reactions of isocyanate groups with isocyanate-reactive functional groups. The conventional catalytically active amounts can be used in this case. Examples of suitable catalysts are organotin compounds such as dibutyltin dilaurate and bismuth compounds such as bismuth lactate.

In the process of the invention the reaction of (A1) with (A2) and, if desired, (A3) is carried out until free isocyanate groups are no longer detectable in the reaction mixture using the conventional qualitative and quantitative detection methods for isocyanate groups.

The reaction of (A1) with (A2) and also, if desired, (A3) can be carried out in bulk (without solvent) or preferably in an inert organic solvent containing no isocyanate-reactive functional groups.

In terms of method the reaction of (A1) with (A2) and also, if desired, (A3) presents no peculiarities but instead takes place in reactors of the kind typically used for the handling and reaction of polyisocyanates, with the conventional safety measures for dealing with polyisocyanates being taken.

The resulting polyols (A) of the invention may serve any of a very wide variety of end uses. Preferably they serve in the context of the inventive use as thermally curable materials of the invention or for preparing thermally curable materials of the invention.

The thermally curable materials of the invention may additionally be curable physically, oxidatively and/or with actinic radiation. By actinic radiation is meant electromagnetic radiation, such as near infrared (NIR), visible light, UV radiation, X-rays, and gamma radiation, especially UV radiation, and particulate radiation, such as electron beams, beta radiation, proton beams, neutron beams, and alpha radiation, especially electron beams.

The materials of the invention are preferably used as new coating materials, adhesives, sealants, and precursors for moldings and films, curable thermally or both thermally and with actinic radiation.

More preferably they are used as coating materials of the invention.

The coating materials of the invention may be conventional coating materials based on organic solvents, aqueous coating materials, pulverulent coating materials, or suspensions of powders (powder slurries). They may be one-component or multicomponent systems, especially two-component systems. More preferably they are two-component systems which are composed of a binder component, which comprises constituents containing isocyanate-reactive functional groups, especially hydroxyl groups, and a crosslinking component, which comprises polyisocyanates.

With particular preference the coating materials of the invention are new electrocoat materials, primers, surfacers, priming systems, basecoat materials, solid-color topcoat materials, and clearcoat materials, especially clearcoat materials.

Viewed in terms of method, the preparation of the thermally curable materials of the invention offers no peculiarities; instead, they are prepared by mixing the polyols (A) of the invention with conventional constituents of coating materials, and subsequently homogenizing the mixtures. Examples of suitable mixing assemblies for preparing the thermally curable materials of the invention are stirred tanks, inline dissolvers, rotor/stator dispersers, Ultraturrax devices, microfluidizers, high-pressure homogenizers or nozzle jet dispersers. Where the thermally curable materials of the invention are to include constituents which can be activated with actinic radiation, it is advisable to exclude actinic radiation when preparing, and subsequently storing, the thermally curable materials of the invention.

The amount of the polyols (A) of the invention in the thermally curable materials of the invention may vary very widely and so be tailored optimally to the requirements of the case in hand. Preferably the amount of (A) is 5% to 95%, more preferably 5% to 90%, very preferably 10% to 80%, and in particular 10% to 70% by weight, based in each case on the solids of the coating material of the invention, the “solids” being the sum of all constituents which constitute the thermoset material of the invention produced from the thermally curable material of the invention.

The customary and known constituents of the coating materials are preferably selected from the group consisting of binders curable oxidatively, physically, thermally and/or with actinic radiation; crosslinking agents; neutralizing agents; organic solvents; reactive diluents curable thermally, with actinic radiation, and both thermally and with actinic radiation; transparent and opaque color pigments, effect pigments, and color and effect pigments; transparent and opaque fillers; nanoparticles; molecularly dispersely soluble dyes; light stabilizers; antioxidants; wetting agents; emulsifiers; slip additives; polymerization inhibitors; thermal crosslinking catalysts; thermolabile free-radical initiators; photoinitiators and photocoinitiators; adhesion promoters; flow control agents; film formation assistants; rheological assistants, flame retardants; corrosion inhibitors; waxes; siccatives; biocides; and matting agents.

They are preferably used in the customary and known, effective amounts.

Where the thermally curable materials of the invention are clearcoat materials or precursors for clear films and moldings, they do not contain opaque constituents.

Examples of suitable constituents of coating materials are known from German patent application DE 199 14 899 A1, page 14, line 36, to page 16, line 63, page 17, line 7, to page 18, line 13, page 18, lines 16 to 21, and page 19, lines 10 to 22 and 30 to 61.

In the context of the inventive use, the thermally curable materials of the invention serve for producing the thermoset materials of the invention.

The thermoset materials of the invention are preferably new coatings, adhesive layers, seals, moldings, and films, especially new coatings.

The coatings of the invention more preferably are new electrocoats, primer coats, surfacer coats or antistonechip primer coats, basecoats, solid-color topcoats, and clearcoats, especially clearcoats.

These coating systems of the invention may be single-coat or multicoat systems. With very particular preference they are multicoat systems and in that case may comprise at least two coats, in particular at least one electrocoat, at least one surfacer coat or antistonechip primer coat, and at least one basecoat and at least one clearcoat, or at least one solid-color topcoat.

With particular preference the multicoat paint systems of the invention comprise at least one basecoat and at least one clearcoat.

It is of particular advantage to produce the clearcoats of the multicoat paint systems of the invention from the clearcoat materials of the invention.

The clearcoats of the invention comprise the outermost coat of the multicoat paint systems of the invention, substantially determining the overall appearance and protecting the color and/or effect basecoats from mechanical, chemical, and radiation-induced damage. In this context the clearcoats of the invention prove to be
particularly insensitive to mechanical stress, such as tension, strain, impacts, scratching or abrasion,
particularly resistant to moisture (in the form of water vapor, for example), solvents, and dilute chemicals, and
particularly resistant toward environmental influences such as temperature fluctuations and UV radiation, and to have
a high gloss and
effective adhesion to any of a very wide variety of substrates.

Not least, they do not exhibit any yellowing following their production.

Depending on intended use, the materials of the invention are applied to temporary or permanent substrates.

For producing films and moldings of the invention it is preferred to use customary and known temporary substrates, such as metallic and polymeric belts or hollow bodies made of metal, glass, plastic, wood or ceramic, which are easily removable without damaging the films and moldings of the invention.

Where the mixtures of the invention are used for producing coatings, adhesive layers, and seals, the substrates employed are permanent.

More preferably the substrates are
means of land, water or air transport operated by muscle power, hot air or wind, such as cycles, railroad trolleys, rowboats, sailboats, hot air balloons, gas balloons, or sailplanes, and parts thereof,
motorized means of land, water or air transport, such as motorcycles, utility vehicles or motor vehicles, especially automobiles, watergoing or underwater craft or aircraft, and parts thereof,
stationary floating structures, such as buoys or parts of harbor installations,
the interior and exterior of buildings,
doors, windows, and furniture, and
hollow glassware,
small industrial parts, such as nuts, bolts, hubcaps or wheel rims,
containers, such as coils, freight containers or packaging,
electrical components, such as electronic windings, coils for example,
optical components,
mechanical components, and
white goods, such as household appliances, boilers and radiators.

The films and moldings of the invention may likewise serve as substrates.

In particular the substrates are automobile bodies and parts thereof. The thermally curable materials of the invention and the coatings of the invention produced from them serve in this case preferably for the OEM finishing of automobile bodes or for the refinishing of inventive and noninventive OEM finishes. The OEM finishes of the invention, particularly those which include a clearcoat of the invention, have outstanding overcoatability. The refinishes of the invention adhere outstandingly to the inventive and noninventive OEM finishes.

In terms of method the application of the thermally curable materials of the invention has no peculiarities but may instead take place by all customary and known application methods that are suitable for the mixture in question, such as electrodeposition coating, injecting, spraying, knifecoating, spreading, pouring, dipping, trickling or rolling, for example. Preference is given to employing spray application methods.

In the course of application it is advisable to operate in the absence of actinic radiation if the thermally curable materials of the invention are additionally curable with actinic radiation.

For the production of the multicoat paint systems of the invention it is possible to employ wet-on-wet methods and coating systems of the kind known, for example, from German patent application DE 199 30 067 A 1, page 15, line 23, to page 16, line 36, or DE 199 40 855 A1, column 30, line 39, to column 31, line 48, and column 32, lines 15 to 29. It is a very important advantage of the inventive use that basically all the coats of the multicoat paint systems of the invention can be produced from the thermally curable materials of the invention. Another is that with wet-on-wet methods there are no strike-in effects.

The thermal curing of the thermally curable materials of the invention takes place or even begins preferably at room temperature.

Alternatively it may take place only after a certain rest time or flash-off time. The flash-off time or rest time may have a duration of 30 seconds to 2 hours, preferably 1 minute to 1 hour, and especially 1 to 45 minutes. The purpose of the rest time is, for example, to allow the applied thermally curable materials of the invention to flow out and undergo devolatization, and for the evaporation of volatile constituents such as any solvent that may be present. Flashing off may be accelerated by means of an elevated temperature and/or a reduced atmospheric humidity.

The thermal curing of the applied thermally curable materials of the invention may be accelerated, for example, by exposure to a gaseous, liquid and/or solid, hot medium, such as hot air, heated oil or heated rolls, or to microwave radiation or infrared and/or near-infrared (NIR) light. Heating takes place preferably in a forced-air oven or by exposure to IR and/or NIR lamps.

Curing with actinic radiation may be carried out by means of the customary and known apparatus and methods, as are described, for example, in German patent application DE 198 18 735 A 1, column 10, lines 31 to 61, German patent application DE 102 02 565 A1, page 9, paragraph [0092], to page 10, paragraph [0106], German patent application DE 103 16 890 A1, page 17, paragraphs [0128] to [0130], international patent application WO 94/11123, page 2, line 35, to page 3, line 6, page 3, lines 10 to 15, and page 8, lines 1 to 14, or the U.S. Pat. No. 6,743,466 B2, column 6, line 53, to column 7, line 14.

The curing of the thermally curable materials of the invention may also be carried out with substantial or complete exclusion of oxygen.

For the purposes of the present invention the oxygen is considered to be substantially excluded when its concentration at the surface of the applied mixtures of the invention is <21%, preferably <18%, more preferably <16%, very preferably <14%, with very particular preference <10%, and in particular <6% by volume.

For the purposes of the present invention the oxygen is considered to be completely excluded when its concentration at the surface is below the limit of the conventional and known detection methods.

The oxygen concentration is preferably ≧0.001%, more preferably ≧0.01%, very preferably ≧0.1%, and in particular ≧0.5% by volume.

The desired oxygen concentrations can be imposed by means of the measures described in German patent DE 101 30 972 C1, page 6, paragraphs [0047] to [0052], or by the laying-on of films.

The resulting thermoset materials of the invention, preferably the films, moldings, coatings, adhesive layers, and seals of the invention, more preferably the coatings of the invention, with very particular preference the electrocoats, primer coats, surfacer coats or antistonechip primer coats, basecoats, solid-color topcoats, and clearcoats of the invention, especially the clearcoats of the invention, are outstandingly suitable for coating, bonding, sealing, wrapping, and packaging the above-described primed or unprimed substrates, and also for mounting on or installation in the primed or unprimed substrates described above.

The resulting substrates of the invention coated with coatings of the invention, bonded with adhesive layers of the invention, sealed with seals of the invention and/or wrapped, packaged and/or joined with films and/or moldings of the invention have outstanding service properties in conjunction with a particularly long service life.

### INVENTIVE AND COMPARATIVE EXAMPLES

### Inventive Example 1

### The Preparation of Branched Polyol (A1)

A reaction vessel equipped with stirrer, reflux condenser, internal thermometer, and inert gas inlet tube was charged under a nitrogen atmosphere with 169.2 parts by weight of Desmodur® Z 4470 from Bayer MaterialScience (trimeric isophorone diisocyanate, isocyanate equivalent weight: 252 g solids/isocyanate equivalent, 70% by weight in butyl acetate). 0.48 part by weight of a five percent strength solution of dibutyltin dilaurate in Solventnaphtha® and 121.5 parts by weight of neopentyl glycol hydroxypivalate (HPN, molecular weight 204 daltons) and 109 parts by weight of butyl acetate were added. The resulting heterogeneous mixture was stirred at room temperature. HPN dissolved in the course of four hours, with a weak exothermic heat profile. The resulting homogeneous mixture was heated at 80° C. with stirring for two hours. After that time free isocyanate groups were no longer detectable in the mixture. The reaction mixture was cooled to room temperature, giving a clear solution of branched polyol (A1) having a theoretical solids content of 60% by weight and a theoretical hydroxyl equivalent weight of 333 g solid resin/hydroxyl equivalent.

### Example 2

### The Preparation of Branched Polyol (A2)

A reaction vessel equipped with stirrer, reflux condenser, internal thermometer, and inert gas inlet tube was charged under a nitrogen atmosphere with 201 parts by weight of Desmodur® Z 4470 from Bayer MaterialScience (trimeric isophorone diisocyanate, isocyanate equivalent weight: 252 g solids/isocyanate equivalent, 70% by weight in butyl acetate). 0.48 part by weight of a five percent strength solution of dibutyltin dilaurate in Solventnaphtha® and 24.2 parts by weight of 2-ethylhexanol (molar weight 130 daltons) were added. The resulting solution was stirred until the exothermic heat profile had subsided. Subsequently 75 parts by weight of cyclohexane-1,4-dimethanol (molecular weight 144 daltons) were added. The resulting heterogeneous mixture was stirred at room temperature, so that the cyclohexane-1,4-dimethanol dissolved over three hours with a weak heat profile and reaction. The reaction mixture was heated at 80° C. for two hours. After that time free isocyanate was no longer detectable in the mixture. The reaction mixture was cooled to room temperature, giving a clear solution of branched polyol (A2) having a theoretical solids content of 60% by weight and a theoretical hydroxyl equivalent weight of 358 g solid resin/hydroxyl equivalent.

### Preparation Example 1

### The Preparation of a Hydroxy-Functional Polyacrylate Resin Binder

A reaction vessel equipped with two feed vessels, stirrer, internal thermometer, inert gas inlet, and reflux condenser was charged with 756 parts by weight of Solventnaphtha®. The solvent was heated to 137° C. At this temperature, beginning simultaneously, a monomer mixture of 173 parts by weight of styrene, 804 parts by weight of ethylhexyl acrylate, 467 parts by weight of hydroxyethyl methacrylate, 259 parts by weight of n-hydroxybutyl acrylate and 26 parts by weight of acrylic acid was metered into the initial charge at a uniform rate from the first feed vessel, over four hours, and an initiator solution of 138 parts by weight of tert-butyl perethylhexanoate and 176 parts by weight of Solventnaphtha® was metered into the initial charge at a uniform rate from the second feed vessel, over 4.5 hours. After the end of the initiator feed the reaction mixture was postpolymerized at 140° C. for two hours more and then cooled. The resulting binder solution was diluted with Solventnaphtha® to a solids content of 65% by weight (determined in a forced-air oven at 130° C. for an hour). The hydroxyl number of the binder was 175 mg KOH/g resin solids, corresponding to a hydroxyl equivalent weight of 320.

### Inventive Examples 3 and 4 and Comparative Example C1

### The Preparation of Binder Components Comprising Branched Polyols (A1) or (A2) of Two-Component Systems (Inventive Examples 3 and 4) and of a Binder Component Comprising a Diol (A′) of a Two-Component System (Comparative Example C1)

### Inventive Example 3

56.6 parts by weight of the binder solution from preparation example 1 were admixed with 63.8 parts by weight of the solution of the branched polyol (A1) of inventive example 1. The resulting mixture was diluted with 12 parts by weight of butyl glycol acetate, 6 parts by weight of Solventnaphtha®, and 11 parts by weight of butyl acetate. The resulting solution was admixed with 0.48 part by weight of Byk® 306 (flow control agent from Altana Chemie) and 0.2 part by weight of a 5% strength by weight solution of dibutyltin dilaurate in Solventnaphtha®. The resulting binder component was stirred at room temperature for five minutes. The binder component remained homogeneous, clear, and transparent even after storage for 14 days.

### Inventive Example 4

78.5 parts by weight of the binder solution from preparation example 1 were admixed with 40.8 parts by weight of the solution of the branched polyol (A2) of inventive example 2. The resulting mixture was diluted with 9.6 parts by weight of butyl glycol acetate, 6 parts by weight of Solventnaphtha®, and 15 parts by weight of butyl acetate. The resulting solution was admixed with 0.48 part by weight of Byk® 306 (flow control agent from Altana Chemie) and 0.2 part by weight of a 5% strength by weight solution of dibutyltin dilaurate in Solventnaphtha®. The resulting binder component was stirred at room temperature for five minutes. The binder component remained homogeneous, clear, and transparent even after storage for 14 days.

### Comparative Example C1

56.6 parts by weight of the binder solution from preparation example 1 were admixed with 19.4 parts by weight of HPN. The mixture was diluted with 12 parts by weight of butyl glycol acetate, 6 parts by weight of Solventnaphtha®, and 28.4 parts by weight of butyl acetate. The resulting solution was admixed with 0.48 part by weight of Byk® 306 (flow control agent from Altana Chemie) and 0.2 part by weight of a 5% strength by weight solution of dibutyltin dilaurate in Solventnaphtha®. The solution was stirred at 45° C. for 40 minutes until HPN was mixed in homogeneously. After just two days of storage the binder component exhibited a turbidity caused by fine HPN crystals. The clearcoat material prepared with this binder component gave a clearcoat which exhibited pinholes. After 14 days' storage the turbid binder component already contained a deposit of HPN crystals. The clearcoat material prepared with this binder component gave a clearcoat which exhibited spits and numerous pinholes.

### Inventive Examples 5 and 6 and Comparative Example C2

### The Preparation of Clearcoat Materials Comprising the Binder Component of Inventive Example 3 (Inventive Example 5) or of Inventive Example 4 (Example 6) and Also of a Clearcoat Material Comprising the Binder Component of Comparative Example C1 (Comparative Example C2)

### Inventive Example 5

The binder component of inventive example 3 was mixed shortly prior to pneumatic spray coating with 49.9 parts by weight of Desmodur® N 3390 from Bayer MaterialScience (polyisocyanate based on hexamethylene diisocyanate, 90 percent in butyl acetate, isocyanate equivalent weight 195 g solids/isocyanate equivalent). The resulting clearcoat material was adjusted with butyl acetate to a spray viscosity of 27.5 seconds in the DIN4 cup. It had a longer pot life or processing life than the clearcoat material of comparative example C2.

### Inventive Example 6

The binder component of inventive example 4 was mixed shortly prior to pneumatic spray coating with 49.4 parts by weight of Desmodur® N 3390 from Bayer MaterialScience (polyisocyanate based on hexamethylene diisocyanate, 90 percent in butyl acetate, isocyanate equivalent weight 195 g solids/isocyanate equivalent). The resulting clearcoat material was adjusted with butyl acetate to a spray viscosity of 27.5 seconds in the DIN4 cup. It had a longer pot life or processing life than the clearcoat material of comparative example C2.

### Comparative Example C2

The binder component of comparative example C1 was mixed immediately after its preparation and shortly prior to pneumatic spray coating with 27 parts by weight of Desmodur® Z 4470 from Bayer MaterialScience (polyisocyanate based on isophorone diisocyanate, 70 percent in butyl acetate, isocyanate equivalent weight 252) and 49.9 parts by weight of Desmodur® N 3390. The resulting clearcoat material had the same overall composition as that of inventive example 3. It was likewise adjusted with butyl acetate to a spray viscosity of 27.5 seconds in the DIN4 cup.

### Inventive Examples 7 and 8 and Comparative Example C3

### The Production of Multicoat Paint Systems Using the Clearcoat Material of Inventive Example 5 (Inventive Example 7) or Using the Clearcoat Material of Inventive Example 6 (Inventive Example 8), and Also Production of a Multicoat Paint System Using the Clearcoat Material of Comparative Example C2 (Comparative Example C3)

### General Procedure:

The clearcoat material was applied using an pneumatic spray gun to test panels which had been coated with an electrocoat, a surfacer coat, and a black basecoat. The resulting clearcoat film was flashed off at room temperature for 10 minutes, dried at 80° C. for 7 minutes, and then cured at 140° C. for 15 minutes. This gave a clearcoat with a film thickness of 45 μm.

The crosslinking conversions of the clearcoat materials of inventive example 5 and of comparative example C2 were determined separately at 140° C. for 40 minutes using the Golden Gate ATR (attenuated total reflection) method. By this measure the clearcoat material of inventive example 4 had a conversion of 92% after 40 minutes and the clearcoat material of comparative example C2 had a conversion of 85%.

The multicoat paint system of comparative example C3 was highly glossy and had a good overall appearance. The multicoat paint systems of inventive examples 7 and 8 were likewise highly glossy, but had a very good overall appearance.

The multicoat paint systems of inventive examples 7 and 8 after 10 cycles in the wash-brush test had a residual gloss of 58% and 56% and after reflow at 60° C. for two hours had a residual gloss of 84% and 83% respectively. The corresponding figures for the multicoat paint system of comparative example C3 were 54% and 82%. Consequently the multicoat paint systems of inventive examples 7 and 8 had a significantly better wet scratch resistance.

The multicoat paint systems of inventive examples 7 and 8 after the Rotahub test had a residual gloss of 93% and 91%. The corresponding residual gloss of the multicoat paint system of comparative example C3 was 82%. Consequently the multicoat paint systems of inventive examples 7 and 8 also had a significantly better dry scratch resistance.

The DaimlerChrysler gradient oven test revealed that the multicoat paint system of inventive example 7 in particular had a better chemical resistance than the multicoat paint system of comparative example C3. Thus initial visible damage by NaOH occurred only at above 49° C., by sulfuric acid only at above 42° C., and by water only at above 50° C. The corresponding temperature levels for the multicoat paint system of inventive example 8 were 41° C., 45° C., and 40° C.; the corresponding temperature values for the multicoat paint system of comparative example C3 were 42° C., 42° C., and 41° C.

At 122 (universal hardness at 25.6 mN, Fischerscope 100V with Vickers diamond pyramid), the multicoat paint system of inventive example 7 had a significantly higher micropenetration hardness than the multicoat paint system of comparative example C3 (micropenetration hardness=113). The micropenetration hardness of the multicoat paint system of inventive example 8 was 108.

The dynamomechanical properties of the clearcoats of inventive examples 7 and 8 and also of comparative example C3 were measured in conventional manner by dynamomechanical analysis (DMA) on homogeneous free films having a thickness of 40±10 μm. At 1.5×10⁷ Pa and 1.3×10⁷ Pa, the clearcoats of inventive examples 7 and 8 had a higher storage modulus E′ in the rubber-elastic range and, at 76° C. and 73° C., a higher glass transition temperature than the clearcoat of comparative example C3 (storage modulus E′=1.2×10⁷ Pa; glass transition temperature=69° C.).

1. A branched polyol (A) comprising on average two or more hydroxyl groups per molecule prepared by reacting
(A1) at least one polyisocyanate comprising on average per molecule two or more isocyanate groups and either
two or more hard segments (a11) which as part of a thermoset three-dimensional network raise its glass transition temperature, or
two or more soft segments which as part of a thermoset three-dimensional network lower its glass transition temperature;
with
(A2) at least one polyol of the general formula I:
X[—R(—OH)ₙ]ₘ (I),
the index and the variables having the following definitions:
n is a number from 1 to 5,
m is 1 or 2,
X is an isocyanate-reactive functional group, and
R is a divalent to pentavalent organic radical, with the proviso that R comprises or consists of at least one hard segment (a11) if (A1) comprises soft segments,
in a molar ratio (A2):(A1) of ≧2 and an equivalent ratio of [X+OH]:NCO≧2.

2. The branched polyol (A) of claim 1, wherein the polyisocyanate (A1) comprises hard segments (a11).

3. The branched polyol (A) of claim 1, comprising on average two or more hydroxyl groups per molecule.

4. The branched polyol (A) of claim 1, wherein the polyisocyanate (A1) comprises three or more isocyanate groups per molecule.

5. The branched polyol (A) of claim 2, wherein the polyisocyanate (A1) comprises three or more hard segments (a11) per molecule.

6. The branched polyol (A) of claim 1, wherein the polyisocyanate (A1) comprises at least one group (a12) selected from the group consisting of isocyanurate, urea, urethane, biuret, uretdione, iminooxadiazinedione, carbodiimide, and allophanate groups.

7. The branched polyol (A) of claim 2, wherein the hard segments (a11) of the polyisocyanates (A1) are selected from the group consisting of saturated and unsaturated cycloaliphatic groups (a13) which are unsubstituted or substituted by inert substituents (a14) and contain heteroatoms (a15) or are free from heteroatoms (a15), and of aromatic groups (a13) which are unsubstituted or substituted by inert substituents (a14) and contain heteroatoms (a15) or are free from heteroatoms (a15).

8. The branched polyol (A) of claim 7, wherein the groups (a11) contain heteroatoms (a15) selected from the group consisting of boron, nitrogen, phosphorus, oxygen, and sulfur atoms.

9. The branched polyol (A) of claim 7, wherein the groups (a11) contain inert substituents (a14) selected from the group consisting of halogen atoms, monovalent, unsubstituted, and perfluorinated aliphatic, cycloaliphatic, and aromatic groups, nitro groups, nitrile groups, and aliphatic, cycloaliphatic or aromatic groups which are linked to the hard segments (a11) of the polyisocyanates (A1) via a carbon-carbon bond or via a divalent linking functional group (a16).

10. The branched polyol (A) of claim 9, wherein the divalent linking functional groups (a16) are selected from the group consisting of ether, thioether, carboxylic ester, thiocarboxylic ester, carbonate, thiocarbonate, phosphoric ester, thiophosphoric ester, phosphonic ester, thiophosphonic ester, phosphite, thiophosphite, sulfonic ester, amide, amine, thioamide, phosphoramide, thiophosphoramide, phosphonamide, thiophosphonamide, sulfonamide, imide, hydrazide, urethane, thiourethane, urea, thiourea, allophanate, carbonyl, thiocarbonyl, sulfone, and sulfoxide groups.

11. The branched polyol (A) of claim 7, wherein the hard segments (a11) of the polyisocyanates (A1) are selected from the group consisting of saturated cycloaliphatic groups (a13) which are unsubstituted or substituted by monovalent aliphatic groups (a14) having 1 to 4 carbon atoms and are free from heteroatoms (a15), and of aromatic groups (a13) which are unsubstituted or substituted by monovalent aliphatic groups (a14) having 1 to 4 carbon atoms and are free from heteroatoms (a15).

12. The branched polyol (A) of claim 7, wherein the saturated, cycloaliphatic hard segments (a11), free from heteroatoms (a15), of the polyisocyanates (A1) are derived from cycloaliphatic compounds (a131) selected from the group consisting of substituted and unsubstituted, monocyclic, bicyclic, tricyclic, and tetracyclic bridge compounds and spirocyclic compounds; and the aromatic hard segments (a11), free from heteroatoms (a15), are derived from aromatic compounds (a131) selected from the group consisting of substituted and unsubstituted, monocyclic and polycyclic, fused and nonfused aromatics.

13. The branched polyol (A) of claim 12, wherein the unsubstituted, monocyclic, bicyclic, tricyclic, and tetracyclic bridge compounds (a131) and spirocyclic compounds (a131) are selected from the group consisting of cyclopropane, cyclobutane, cyclopentane, cyclohexane, cycloheptane, cyclooctane, p-menthane, m-menthane, o-menthane, 1,1,2,3-tetramethylcyclohexane, 1,1,3,3-tetramethylcyclohexane, thujane, carane, pinane, bornane, norcarane, norpinane, norbornane, camphane, 2-ethylpinane, 2,4,7,7-tetramethylnorcarane, 2,2-dimethylnorbornane, hydroindane, dicyclohexylmethane, 2,2-dicyclohexylpropane, perhydronaphthalene, perhydroacenaphthene, perhydrophenanthrene, perhydroanthracene, perhydrofluorene, abietane, pimarane, labdane, phyllocladane, gibbane, gonane, cholestane, lanostane, ambrane, onacerane, oleanane, ursane, gammacerane, lupane, bicyclo[2.2.2]octane, bicyclo[3.2.1]octane, bicyclo[5.2.0]nonane, bicyclo[4.3.2]undecane, tricyclo[2.2.1.02.6]heptane, tricyclodecane, tricyclo[5.4.0.02.9]undecane, tricyclo[5.3.2.04.9]dodecane, tricyclo[5.5.1.03.11]tridecane, perhydro-1,4-ethano-5,8-methanoanthracene, adamantane, spiro[3.3]heptane, spiro[3.4]octane, spiro[4.5]decane, spirobicyclohexane, and dispiro[5.1.7.2]heptadecane; and the monocyclic and polycyclic, fused and nonfused aromatics (a131) are selected from the group consisting of benzene, toluene, xylene, tetramethylxylene, biphenyl, diphenylmethane, 2,2-diphenylpropane, 1,2-, 1,3- or 1,4-diphenylbenzenes (terphenyls), positionally isomeric quaterphenylenes, 1,3,5-triphenylbenzene, naphthalene, acenaphthylene, acenaphthene, phenanthrene, fluorene, anthracene, chrysene, pyrene, and fluoranthene.

14. The branched polyol (A) of claim 13, wherein the unsubstituted, monocyclic, bicyclic, tricyclic, and tetracyclic bridge compounds (a131) and spirocyclic compounds (a131) are selected from the group consisting of cyclobutane, cyclopentane, cyclohexane, 1,1,3,3-tetramethylcyclohexane, 2-ethyl-1,3,3-trimethylcyclohexane, 3-propyl-1,3,3-trimethylcyclohexane, 4-butyl-1,3,3-trimethylcyclohexane, ethylcyclohexane, propylcyclohexane, butylcyclohexane, dicyclohexylmethane, 2,2-dicyclohexylpropane, benzene, toluene, tetramethylxylene, diphenylmethane, and 2,2-diphenylpropane.

15. The branched polyol (A) of claim 2, wherein the polyisocyanate (A1) is selected from the group consisting of isophorone diisocyanate (i.e., 5-isocyanato-1-isocyanatomethyl-1,3,3-trimethylcyclohexane), 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane 2,4′-diisocyanate, dicyclohexylmethane 4,4′-diisocyanate, tolylene 2,4- and 2,6-diisocyanate, phenylene 1,2-, 1,3- or 1,4-diisocyanate, naphthalene 1,4-, 1,3-, 1,2-, 1,5- or 2,5-diisocyanate, propane-2,2-di(phenyl 4′-diisocyanate), methanedi(phenyl 4′-isocyanates) or 1,1′-diphenyl 4,4′-diisocyanate, and also the oligomers thereof.

16. The branched polyol (A) of claim 15, wherein the polyisocyanate (A1) comprises diisocyanate oligomers (A1) that comprise groups selected from the group consisting of isocyanurate, urea, urethane, biuret, uretdione, iminooxadiazinedione, carbodiimide, and allophanate groups (a12).

17. The branched polyol (A) of claim 1, wherein the index n of the general formula I is an integer from 1 to 5.

18. The branched polyol (A) of claim 17, wherein the index n of the general formula I is 1 or 2.

19. The branched polyol (A) of claim 1, wherein the isocyanate-reactive functional group X of the general formula I is selected from the group consisting of hydroxyl groups, thiol groups, primary amino groups, and secondary amino groups —NH—.

20. The branched polyol (A) of claim 19, wherein the isocyanate-reactive functional group X is a hydroxyl group.

21. The branched polyol (A) of claim 1, wherein the organic radical R of the general formula I is divalent or trivalent.

22. The branched polyol (A) of claim 1, wherein the organic radical R of the general formula I is selected from the group consisting of
radicals which comprise saturated and unsaturated, aliphatic, cycloaliphatic, and aromatic radicals which are unsubstituted or substituted by inert substituents (a14), contain heteroatoms (a15) or are free from heteroatoms (a15), and contain or are free from divalent linking functional groups (a16), and
radicals which consist of saturated and unsaturated, aliphatic, cycloaliphatic, and aromatic radicals which are unsubstituted or substituted by inert substituents (a14), contain heteroatoms (a15) or are free from heteroatoms (a15), and contain or are free from divalent linking functional groups (a16).

23. The branched polyol (A) of claim 1, wherein the radical R contains 2 to 50 carbon atoms.

24. The branched polyol (A) of claim 1, wherein the polyol (A2) of the general formula I is selected from the group consisting of diols, triols, tetrols, pentitols, hexitols, thioalkanols, and alkanolamines.

25. The branched polyol (A) of claim 1, wherein up to 30 mol % of the polyol (A2) of the general formula I is replaced by at least one compound (A3) of the general formula II:
X—R¹ (II),
in which the variable X has the definition indicated above and the variable R¹ is a monovalent organic radical.

26. A process for preparing a branched polyol (A) comprising on average two or more hydroxyl groups per molecule, as claimed in claim 1, which comprises reacting
(A1) at least one polyisocyanate comprising on average per molecule two or more isocyanate groups and either
two or more hard segments (a11) which as part of a thermoset three-dimensional network raise its glass transition temperature, or
two or more soft segments which as part of a thermoset three-dimensional network lower its glass transition temperature;
with
(A2) at least one polyol of the general formula I:
X[—R(—OH)ₙ]ₘ (I),
the index and the variables having the following definitions:
n is a number from 1 to 5,
m is 1 or 2,
X is an isocyanate-reactive functional group, and
R is a divalent to pentavalent organic radical, with the proviso that R comprises or consists of at least one hard segment (a11) if (A1) comprises soft segments,
in a molar ratio (A2):(A1) of ≧2 and an equivalent ratio of [X+OH]:NCO≧2, until free isocyanate groups are no longer detectable in the reaction mixture.

27. The process of claim 26, wherein up to 30 mol % of the polyol (A2) of the general formula I is replaced by at least one compound (A3) of the general formula II
X—R¹ (II),
in which the variable X has the definition indicated above and the variable R¹ is a monovalent organic radical.

28. The process of claim 26, wherein the molar ratio (A2):(A1) or [(A2)+(A3)]:(A1) is ≧2 to 5 and the equivalent ratio [X+OH]:NCO is ≧2 to 4.

29. A thermally curable material comprising the branched polyol of claim 1.

30. The thermally curable material of claim 29, wherein the thermally curable material is additionally curable physically, oxidatively and/or with actinic radiation.

31. A method of making thermoset materials comprising using the thermally curable materials of claim 29.

32. The method of claim 31 wherein the thermally curable materials are at least one of the group consisting of coating materials, adhesives, sealants, and precursors for moldings and films.

33. The method of claim 32, wherein the coating materials are at least one of the group consisting of electrocoat materials, primers, surfacers, priming systems, basecoat materials, solid-color topcoat materials, and clearcoat materials.

34. The method of claim 33, wherein the coating materials are clearcoat materials.

35. The method of claim 31, wherein the thermoset materials are coatings, adhesive layers, seals, moldings or films.

36. The method of claim 35, wherein the coatings are at least one of the group consisting of electrocoats, primer coats, surfacer coats, antistonechip priming coats, basecoats, solid-color topcoats and clearcoats on primed or unprimed substrates.

37.-40. (canceled)
